(19) United States
(12) Patent Application Publication
(10) Pub. No.: US 2023/0062298 A1
(43) Pub. Date: Mar. 2, 2023

(54) LIDAR INTERFERENCE MITIGATION VIA MODULATED SPATIO-TEMPORAL SCANNING

(71) Applicant: Seagate Technology LLC, Fremont, CA (US)

(72) Inventors: Adam R. BUSH, Plymouth, MN (US); Kevin A. GOMEZ, Eden Prairie, MN (US); Eric James DAHLBERG, Eden Prairie, MN (US)

(21) Appl. No.: 17/823,490

(22) Filed: Aug. 30, 2022

Related U.S. Application Data
(60) Provisional application No. 63/238,618, filed on Aug. 30, 2021.

(51) Int. Cl. G01S 7/487; G01S 7/481; G01S 7/4861; G01S 7/486

(52) U.S. Cl. CPC G01S 7/4873; G01S 7/4817; G01S 7/4861; G01S 7/4868

(57) ABSTRACT

Interference mitigation for a LiDAR system includes identifying a presence or absence of interference from a non-co-located light source in a sample of incident light received by a detector in the LiDAR system. In the absence of interference, a nominal set of reference values is used for one or more spacio-temporal scanning profile trajectory parameters. Scanner components of the LiDAR system are controlled using the nominal set of reference values. In the presence of interference, the nominal set of reference values is augmented to modify the spacio-temporal scanning profile trajectory parameters. Scanner components of the LiDAR system are controlled using the augmented set of reference values to avoid detection of and interference by the non-co-located light source.

### CROSS-REFERENCE TO RELATED APPLICATIONS

This application claims the benefit of priority pursuant to 35 U.S.C. § 119(e) of U.S. provisional application No. 63/238,618 filed 30 Aug. 2021 entitled “LiDAR interference mitigation via modulated spatio-temporal scanning,” which is hereby incorporated herein by reference in its entirety.

### BACKGROUND

Light detection and ranging (LiDAR) is a technology that measures a distance to an object by projecting a laser toward the object and receiving the reflected laser light. The distance is generally calculated from the time of flight (ToF) of the laser light, i.e., the time between generation of the laser light at the LiDAR device and the time a reflection of the laser light is received at a detector at the LiDAR device. The speed of light is a known value and the return trip time is easily converted into distance. Multiple light pulses transmitted at different angles, or a dispersed light transmission, can be used to increase accuracy by triangulation calculations based upon light received at different angles at the detector. Scanning LiDAR provides a more accurate representation of a wide field of view (FoV) by moving the laser light beam, or pulses of laser light, rapidly back and forth and up and down over an area, similar to the movement of an electron beam on the cathode-ray tube of original generation television. Unlike television, however, LiDAR systems operate by detecting the reflected light to discern objects in the field of view. Thus, reducing interference of other light sources with the returning light from the LiDAR laser is important to creating an accurate image of objects in the field of view as well as determining their distance from the LiDAR device.

The information included in this Background section of the specification, including any references cited herein and any description or discussion thereof, is included for technical reference purposes only and is not to be regarded subject matter by which the scope of the invention as defined in the claims is to be bound.

### SUMMARY

The technology disclosed herein pertains to interference detection and mitigation for mechanical scanning LiDAR systems. Example implementations of the system and methods disclosed detect and reject and/or adjust LiDAR performance parameters to mitigate interference and to maintain detection accuracy.

In one example implementation, a method of interference mitigation in a LiDAR system is disclosed. A presence or absence of interference from a non-co-located light source may be identified in a sample of incident light received by a detector in the LiDAR system. In the absence of interference. A nominal set of reference values may be used for one or more spacio-temporal scanning profile trajectory parameters. One or more scanner components of the LiDAR system may be controlled using the nominal set of reference values. In the presence of interference, the nominal set of reference values may be augmented, resulting in an augmented set of reference values, to modify the spacio-temporal scanning profile trajectory parameters. The one or more scanner components of the LiDAR system may be controlled using the augmented set of reference values to avoid detection of and interference by the non-co-located light source.

In another example implementation, a LiDAR device may include a system for mitigating interference from a non-co-located light source. The system may include a detector, a scan profile generator, and a controller. The detector identifies a presence or absence of interference from a non-co-located light source in a sample of incident light received at the detector. The scan profile generator may be configured to generate a nominal set of reference values for one or more spacio-temporal scanning profile trajectory parameters in the absence of interference. The scan profile generator may also be configured to adjust the nominal set of reference values to generate an augmented set of reference values to modify the spacio-temporal scanning profile trajectory parameters in the presence of interference. The controller controls one or more scanner components of the LiDAR device using either the nominal set of reference values or the augmented set of reference values to avoid detection of and interference by the non-co-located light source.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example schematic of a mechanical scanning LiDAR system.

FIG. 2 illustrates an alternate view of some of the components of the mechanical scanning LiDAR system of FIG. 1.

FIGS. 3A, 3B, and 3C illustrate example orientations of optical components of the LIDAR interference detection and mitigation system disclosed herein.

FIGS. 4A, 4B, and 4C illustrate example graphs of nominal sampling trajectories of the LIDAR interference detection and mitigation system disclosed herein.

FIGS. 5A, 5B, and 5C illustrate example graphs with application of offsets to the nominal sampling trajectories disclosed in FIGS. 4A, 4B, and 4C, respectively, of the LIDAR interference detection and mitigation system disclosed herein.

FIGS. 6A, 6B, and 6C illustrate example graphs with application of stretching and/or compression of the nominal sampling trajectories disclosed in FIGS. 5A, 5B, and 5C, respectively, of the LIDAR interference detection and mitigation system disclosed herein.

FIG. 7 illustrates a block diagram of an example LIDAR interference detection and mitigation system disclosed herein.

FIG. 8 illustrates an example flow diagram of a method for LIDAR interference detection and mitigation.

FIG. 9 illustrates an example processing system that may be useful in implementing the described technology.

### DETAILED DESCRIPTION

The technology disclosed herein provides methods of detecting and rejecting interfering light reflections or adjusting LiDAR performance parameters to mitigate interference and maintain detection accuracy. One or more implementations disclosed herein provide systems and methods of interference detection and mitigation by a scanning LiDAR system. However, the implementations disclosed may be generalized to any LiDAR implementation.

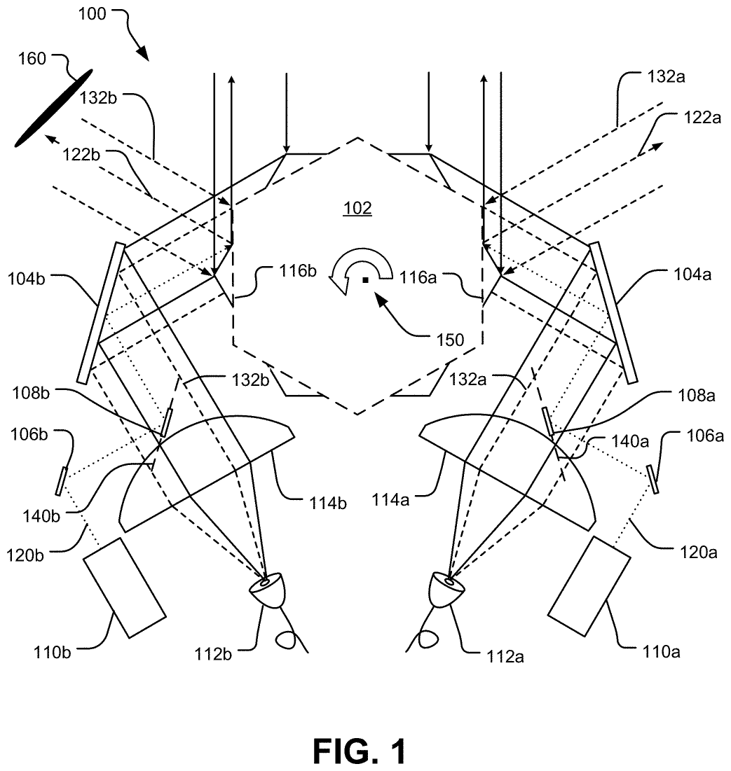

An example mechanically scanning LiDAR device 100, e.g., for automotive applications, is presented schematically in FIG. 1. The mechanically scanning LiDAR device 100 may include of two laser sources 110a, 110b, two optical detectors 112a, 112b, two collection lenses 114a, 114b, two vertical scan mirrors 104a, 104b (also referred to as “galvo mirrors”), and one polygonal, rotating, horizontal scan mirror 102 with n sides. In FIG. 1, component elements that are configured in substantial symmetry are indicated by “a” and “b” with respect to the corresponding reference numeral. When referring to such symmetric components together in the text, only the reference numeral may be used to refer to both of such symmetric components. Thus, for example, laser sources 110a and 110b may be referred to together as laser sources 110, detectors 112a and 112b may be referred to together as detectors 112, etc.

In one implementation, each laser source 110 is directed into a respective vertical scan mirror 104 by auxiliary mirrors 106 and 108. The vertical scan mirrors 104 direct the laser light (either continuous or pulsed) from the laser sources 110 to raster vertically (up and down) across a field of view (FoV) as the vertical scan mirrors 104 articulate. The vertical scan mirrors 110 are each mounted on horizontal pivot axes 140 resulting in laser light reflection at positive (upward) or negative (downward) angles from horizontal as the vertical scan mirrors 104 pivot back and forth on the pivot axes 140. In one implementation, the vertical scan mirrors 110 oscillate about horizontal axes at 5 Hz per cycle about ±7.2° to provide a vertical scan range of about ±10° or 20° total.

In the embodiment of FIG. 1, the horizontal scan mirror 102 may be hexagonally shaped and rotates on a vertical axis 150, orthogonal to the axes 140 of the vertical scan mirrors 104. In alternative implementations, the horizontal scan mirror 102 may be a 3-, 4-, 5-, or 7-sided polygonal mirror. The horizontal scan mirror 102 rotates at a very high speed, e.g., hundreds of rotations per second. Each facet 116 of the hexagonal shape of the horizontal scan mirror 102 successively sweeps the laser pulses from the laser sources 110 horizontally across the field of view as the horizontal scan mirror 102 rotates. In an embodiment using a hexagonal-shaped horizontal scan mirror 102, each facet 116 receives the laser light at angles of between 0° and 30° as each facet moves in and out of the laser beam. This translates into a horizontal sweep over the field of view of between 0° and 60° as the horizontal scan mirror 102 rotates. As the horizontal scan mirror 102 rotates, the angle of reflection changes dependent on the angle of the facet 116 at any given instant. Thus, the horizontal scan mirror 102 effectively scans the light beam 120 horizontally in the plane of the page of FIG. 1, while and the vertical scan mirrors 104 effectively scan the light beam 120 across the field of view in two independent dimensions. Further, due to the configuration with two laser sources 110 and two vertical scan mirrors 104 reflecting light to opposite facets 116 of the horizontal scan mirror 102, the LiDAR device 100 effectively doubles the horizontal field of view to about 120°.

In FIG. 1, the light beam 120 reflected from the horizontal scan mirror 102 is shown as outgoing beam 122. Objects 160 in the field of view which reflect light bounce scattered light back toward the LiDAR device 100. After colliding with an object 160, the back-scattered light beam 132 reflects off a facet of the horizontal scan mirror 102 and is directed toward the vertical scan mirrors 104 in reverse direction. The back-scattered light beam 132 reflects of the vertical scan mirrors 104 toward the collection lenses 114. The collection lenses 114 focus the back-scattered light beam 132 toward the detectors 112. By relating the time of generation of light at the laser sources 110 to the time of receipt by the detectors 112, the mechanically scanning LiDAR device 100 can estimate the distance of the object in the field of view. Scanning thousands of laser pulses per second at different mirror positions, up and down and back and forth across the field of view, allows the LiDAR device 100 to map the field of view in the surrounding environment in three dimensions.

It should be understood that the actual implementation of the mechanically scanning LiDAR device 100 need not fit the precise geometric configuration as pictured in FIG. 1. In alternative implementations, the angles and component arrangements may be different than that disclosed in FIG. 1.

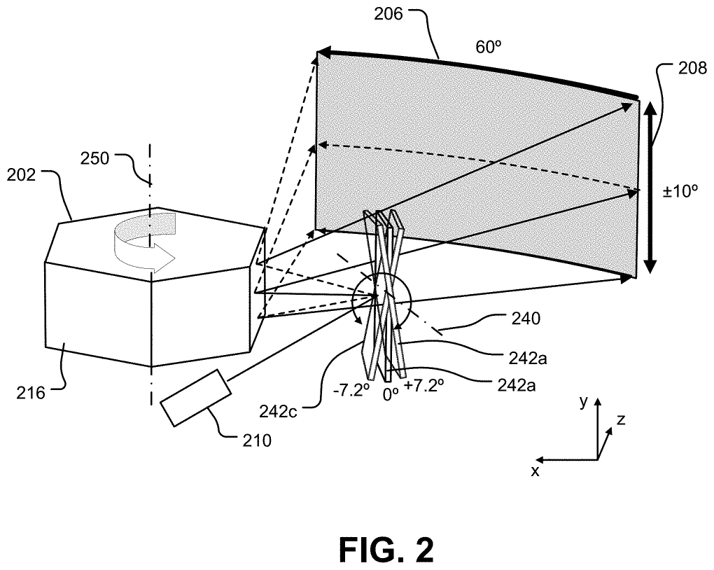

FIG. 2 schematically presents an isometric view of some of the components of a LiDAR device 200 to better depict the scan area and related field of view achieved. As in FIG. 1, the horizontal scan mirror 202 may be hexagonally shaped and rotates on a vertical axis 250. The vertical scan mirror 210 is mounted on a horizontal pivot axis 240 and moves between a vertical position 242a and a positive deflection angle 242b of 7.2° from vertical and a negative deflection angle 242c of −7.2° from vertical. As the vertical scan mirror 204 pivots back and forth on the pivot axis 240, laser light from the laser source 210 is reflected to the facets 216 of the horizontal scan mirror 202 at different heights between ±10° from a middle horizontal. The laser light then reflects off the facets 216 of the horizontal scan mirror 202 into the field of view. The horizontal scan mirror 202 thus provides a horizontal scan range of about 60° and the vertical scan mirror 210 similarly provides a vertical scan range 208 of about 20°.

As mentioned above, systems employing LiDAR sensor devices allow extraction of range information for objects in a field of view by detecting returning light emitted from a known laser source or sources at known times and orientations. Intensity information of the returning light may also be used to determine range or surface features of objects in the field of view. Interference in LiDAR systems may occur when the reflected signal received at the detector contains information from another source which is not known to the LiDAR or otherwise not compensated for. For mechanical scanning LiDAR systems, the detection window during which interference may occur will correspond to a given region of space at a particular moment in time within the field of view of the LiDAR sensors. Thus, interference sources may be considered as having the following attributes relative to the field of view of the LiDAR sensors: (a) angular area, (b) duration, and (c) trajectory, which are referred to herein as spatio-temporal attributes. Additionally, data for determination of LiDAR sampling trajectories may include (a) an orientation of the sampling optics at a known time and (b) a sample timing window in which the sample is collected.

Interference occurs when there is an intersection between the spatio-temporal attributes of the interference source and the sampling trajectory of the sensors of a LiDAR device. Additionally, interference sources may be passive or adversarial. For example, passive interference could occur due to the presence of other LiDAR systems which are interrogating a shared space. One particular example of such passive interference is when two automobiles with LiDAR systems (e.g., for safety ranging or autonomous driving) are stopped adjacent to each other for an extended period of time (e.g., in a traffic jam). Another example may be in the context of an automation line in which LiDAR sensors are mounted side-by-side. Over time, there is a likelihood that two adjacent systems will drift and send light pulses in relative synchronization with each other, thus causing interference with return signals indicating objects at wrong angles or positions with respect to each vehicle, blurring the resolution of objects in the field of view, or even injecting an artificial structure into the image (similar to an augmented reality image). While the rate of occurrence for interference artifacts in passive interference may not happen often, mitigation is still necessary for accuracy and safety. Adversarial interference could occur due to deliberate actions taken by another entity to purposefully interfere with the LiDAR sensor operation. For example, in a combat situation, an opposing force could irradiate an area with light sources in a deliberate attempt to foil ranging for munitions targeting or drone navigation. If a LiDAR sensor is overwhelmed by light, there is a time delay to reset sensor. Further, mechanical constraints in the rotation speed of the horizontal scan mirror or pivot speed of the vertical scan mirror limit the speed of sensor input and potentially the ability to discern between light sources.

Notably, the interference mitigation solutions disclosed herein are concerned with interference between or caused by separate, non-co-located LiDAR systems or a LiDAR system and a separate light source. This situation is distinct from addressing potential interference between co-located, synchronized lasers in a single housing or device or multiple lasers in a distributed LiDAR system that are under common control. The primary issue with separate systems under separate control is that there is no ability to formally synchronize both systems. In contrast, LiDAR systems with multiple laser sources under common control can avoid interference in multiple ways, e.g., by alternating or interleaving light pulses, using different scanning patterns, using different frequencies or phases, or otherwise algorithmically differentiating received light between co-located laser sources based upon exit trajectories.

The disclosed technology herein initially recognizes or detects interference from a separate LiDAR device, e.g., due to accidental synchronization and then deploys one or more mitigation techniques as further described below. The goal is to recognize interference and then cause the LiDAR device to randomly step away from the pattern of the other, interfering LiDAR device. For interference sources that occupy a subset of the spatio-temporal characteristics of a LiDAR sensor sampling trajectory, it may be possible to mitigate the extent of interference by altering the characteristics of the LiDAR sensor sampling trajectory. For example, changes could be made to the location of sample outside of the normal raster scan pattern; the density of light pulses in certain areas of the field of view could be algorithmically altered to shift the focus location; the timing of laser pulses could be changed (e.g., closer together, further apart, randomized); sampling of detected reflections could be altered to sample particular locations at particular times; etc.

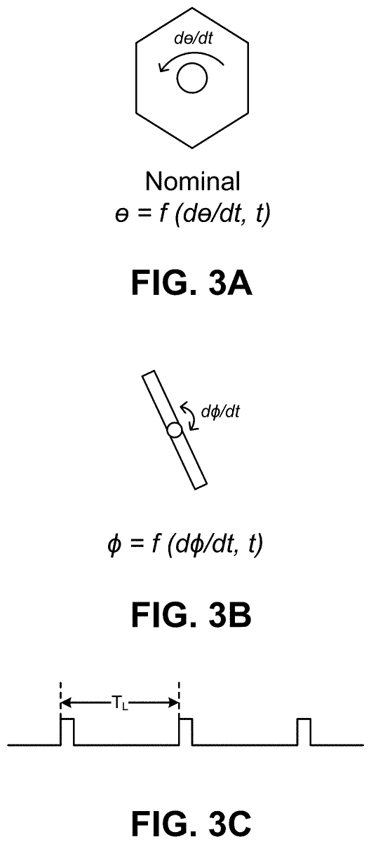

FIGS. 3A, 3B, and 3C illustrate example, nominal orientations and states (i.e., without interference) of optical components of the LiDAR interference detection and mitigation system disclosed herein. In FIG. 3A, theta (θ) refers to the horizontal angle of light across the field of view as reflected off a horizontal scan mirror. Theta (θ) is thus a function of the angular velocity of the spinning polygonal horizontal scan mirror (dθ/dt) and time (t). In FIG. 3B, phi (ϕ) refers to the vertical angle of light across the field of view as reflected off a vertical scan mirror (galvo). Phi (ϕ) is thus a function of angular velocity (dϕ/dt) and time (t). In FIG. 3C, time (T_{L}) is the sampling window time at the detector in the LiDAR device and is a function of the laser fire timing.

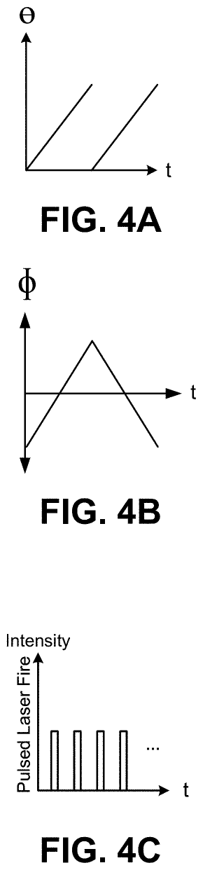

FIGS. 4A, 4B, and 4C illustrate example graphs of nominal sampling trajectories of the LIDAR interference detection and mitigation system disclosed herein. FIG. 4A depicts the cyclic recurrence of field of view angle theta (θ) (e.g., from right to left for a counterclockwise rotation) as each facet of the polygonal horizontal scan mirror intercepts the laser beam/pulses from one edge to the other. For example, for a hexagonal-shaped scan mirror, theta (θ) will be between 0° at the leading edge of the facet and 30° at the trailing edge of the facet. FIG. 4B depicts the cyclic recurrence of field of view angle phi (ϕ) (e.g., from down, to up, to down for a full back and forth pivot) as the vertical scan mirror intercepts the laser beam/pulses from one edge to the other. For example, for a vertical scan mirror pivoting between −7.2° and +7.2°, theta phi (ϕ) will be between −10° when the top edge of the vertical scan mirror is tipped toward the horizontal scan mirror and +10° when the bottom edge of the vertical scan mirror is tipped toward the horizontal scan mirror, resulting in a total vertical field of view of 20°. FIG. 4C depicts a series of laser pulses of identical intensity over time at a constant, equivalent pulse rate and pulse width. (Note that time t is not to scale between various plots of FIGS. 4A, 4B, and 4C.) FIGS. 3A-4C thus depict the nominal operation of the interference mitigating LiDAR system, i.e., when no interference is detected.

These nominal trajectory values may further be used to determine the presence of interference in reflected light signals as further described below. For example, the spacio-temporal characteristics of light pulses sent from the LiDAR device with interference detection as disclosed here are known and thus typical characteristics of returning light can be modeled. If characteristics of the light received at the detector is significantly different than the known characteristics associated with nominal trajectories and pulses, such differences could indicate interference from a separate device or light source and a need to initiate mitigation techniques. Additionally, the spacio-temporal aspects of other common LiDAR systems could be modeled in advance and those characteristics could be compared to incoming reflections detected to determine whether interference from known LiDAR systems is likely. If so, mitigation techniques could be initiated.

In one exemplary implementation, when interference is detected, one or more dithering techniques can be applied to the light transmitted from the LiDAR device in order to differentiate the light generated at the LiDAR device from possible interfering light sources. “Dither” is an intentionally applied form of noise or signal variation used to randomize a signal against competing signals for better identification. In the present implementation, dither make take the form of randomization of the sampling trajectory or orientation in space, consistent but non-nominal offsets of the sampling orientation or sampling windows, or randomized offsets of timing of the sampling windows among others.

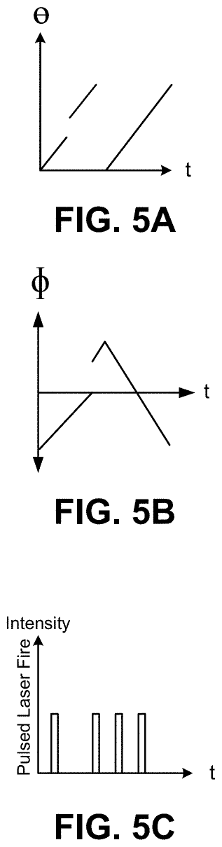

FIGS. 5A, 5B, and 5C illustrate example graphs with application of dithering via offsets to the nominal sampling trajectories and timing of sampling windows disclosed in FIGS. 4A, 4B, and 4C, respectively, of the LIDAR interference detection and mitigation system disclosed herein. FIG. 5A depicts an example horizontal angular offset in the scanned field of view wherein a portion of the field of view may be skipped in one cycle of the scan, e.g., by instantaneously increasing the rotational speed (dθ/dt) of the horizontal scanning mirror between light pulses and then slowing the rotational speed slightly to end the facet at the normal end of the scanning field of view. In this example, the rotational speed may then return to nominal for the next cycle. FIG. 5B depicts an example of vertical angular offset in the scanned field of view wherein a portion of the field of view may be skipped in one cycle of the scan, e.g., by instantaneously increasing the pivot speed (dϕ/dt) of the vertical scanning mirror between light pulses and then slowing the pivot speed slightly to end the mirror travel at the normal end of the scanning field of view. FIG. 5C depicts an example of a timing offset between sampling windows. This offset could coincide with similar timing offsets in the firing of the laser pulses or could merely skip sampling of some of the laser pulses in an attempt to avoid the interfering signals if, for example, the interfering signals are on a slightly different cycle. Each of these examples of dither could be implemented separately and solely, or could be implemented in combination with two or more other dithering techniques to mitigate interference.

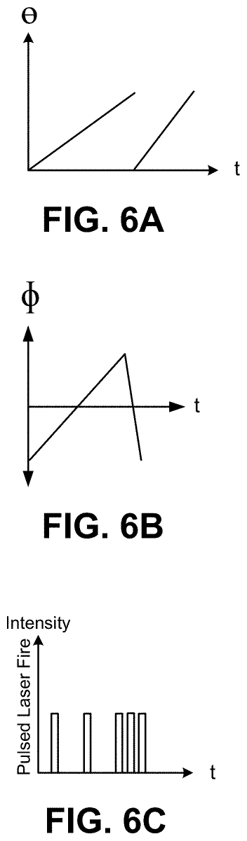

In another exemplary implementation, when interference is detected, techniques involving stretching or compression of the trajectories of the signals, or of the sample windows at the detector, or of the timing of laser pulses from the laser sources of the LiDAR device can be applied to differentiate the light generated at the LiDAR device from possible interfering light sources. FIGS. 6A, 6B, and 6C illustrate example graphs with application of stretching and/or compression of the nominal sampling trajectories disclosed in FIGS. 4A, 4B and 4C, respectively, of the LIDAR interference detection and mitigation system disclosed herein. FIG. 6A depicts an example wherein the horizontal scan of the field of view for a first scan cycle is lengthened from the nominal period, e.g., by decreasing the rotational speed (dθ/dt) of the horizontal scanning mirror between light pulses for a first facet. In the second cycle shown in the graph of FIG. 6A, the horizontal scan of the field of view is shortened from the nominal period, e.g., by increasing the rotational speed (dθ/dt) of the horizontal scanning mirror between light pulses for a second facet. Changes in rotational speed of the horizontal scan mirror can be randomly made to stretch or compress the horizontal scan trajectory until the interference wanes.

FIG. 6B depicts a similar example of stretching and compressing vertical angular offset in the scanned field of view. In a first cycle, the pivot speed (dϕ/dt) of the vertical scan mirror is slowed from the nominal speed for the cycle resulting in a longer vertical scan time and potentially more pulses within the height of the vertical field of view. In contrast, as shown in the plot of the second cycle on the graph, the pivot speed (dϕ/dt) of the vertical scan mirror is increased from the nominal speed for the cycle resulting in a shorter vertical scan time and potentially fewer pulses within the height of the vertical field of view. FIG. 5C depicts an example of a timing offset between sampling windows. This offset could coincide with similar timing offsets in the firing of the laser pulses or could merely skip sampling of some of the laser pulses in an attempt to avoid the interfering signals if, for example, the interfering signals are on a slightly different cycle.

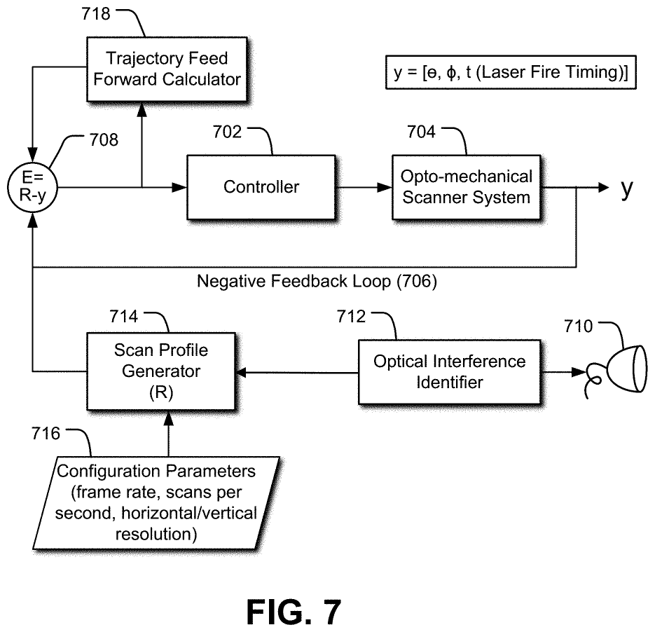

FIG. 7 illustrates an example block diagram of a LIDAR interference detection and mitigation system 700 disclosed herein. The LIDAR interference detection and mitigation system 700 mitigates interference by altering the characteristics, e.g., spacio-temporal scanning profile trajectory parameters, of the LiDAR scanner trajectories and sensor sampling orientation by one or more of the methods described above. For example, in some implementations the LIDAR interference detection and mitigation system 700 may dither scanning profile trajectories or a sample timing window for detecting LiDAR signal at a LiDAR sensor or stretch or compress a scanning profile trajectory for at least one of the sample angle and sample window timing. In other implementations, or in addition, the LIDAR interference detection and mitigation system 700 may model sensor sampling trajectories for known LiDAR sensors which can interfere and uses those models to adjust the sampling trajectory to mitigate interference.

The system 700 may include a controller 702, e.g., a processor or a RISC chip, configured with processing instructions to adjust the LiDAR system components to perform the scanning operations. The controller 702 controls the function of the opto-mechanical scanner system 704, i.e., the horizontal scan mirror, the vertical scan mirror(s), and the laser source(s). When there is no interference, the controller 702 adjusts the movements of the mirrors and the firing times of the pulses according to the nominal values. If interference detected, the instructions generated for the controller 702 will cause the controller 702 to change the rotational and pivot speeds of the mirrors and/or change the timing of the laser pulses to alter the spacio-temporal sampling trajectories to mitigate the interference. The positions of the scan mirrors and the timing of the laser pulses (i.e., θ, ϕ, and t) at the time of firing of a pulse are represented as the data set “y”, wherein a separate data set is generated for each light pulse transmitted from the LiDAR device. Each data set y of trajectory and timing values is returned through a negative feedback loop 706 to error calculator 708.

Trajectory parameters of light received at the detector(s) 710 of the LiDAR device are passed to an optical interference identifier 712 to recognize or detect possible interference based upon characteristics of detected light signals. For one example embodiment of interference detection, the optical interference identifier 712 may maintain a statistical model of the scene or structure of objects captured within the LiDAR field of view based on previously capture measurements spanning one or more frames. This model may be built using one or more of a variety of forms, for example, simultaneous localization and mapping (SLAM), point clustering, etc. The model can then be used to predict the likelihood that subsequent measurements taken correspond to structure in the scene versus spurious measurements that may be the result of interfering light sources. Spurious measurements can then be further subcategorized into, for example, interference or noninterference based on a predefined set of interference characteristics stored in a table. These characteristics may include predefined point cluster geometries across multiple frame measurements, for example, one or more streaks of points, the positions of which do not follow expected trajectories across multiple sequential frames. If the spurious measurements meet the criteria indicated in the table, the optical interference identifier 712 will trigger a state of interference as opposed to a standard state when there is no interference.

The interference state output from the optical interference identifier 712 is received in a scan profile generator 714, which functions to calculate the base trajectory and pulse timing values for the controller 702. The calculations performed by the scan profile generator 714 are primarily based upon configuration parameters 716 that determine the locations of each light pulse in the sequence of light pulses to create a desired raster scan profile across the field of view. Typical configuration parameters 716 may include frame rate, scans per second, horizontal/vertical resolution, etc. If the interference state output from the optical interference identifier 712 is null or standard, i.e., there is no interference, then the reference values (R) generated by the scan profile generator 714 are the nominal trajectory values. However, if the optical interference identifier 712 detects interference in received light, the interference state output is ingested by the scan profile generator 714 to adjust the reference values (R). Upon receiving an indication of a state of interference, the scan profile generator 714 will deploy predefined or adaptively defined modifications to the reference values (R) to avoid reception of light interference at the detector(s) 710 in future samples for a window of time. For example, reference value (R) may be adjusted by the scan profile generator 714 in a variety of ways as described, for example, with respect to FIGS. 5A-6C to introduce random dither in trajectory or timing values, to stretch or compress trajectory or timing values using slope offsets, or to introduce particular trajectory slope offsets or timing changes to avoid known trajectories and timing used by other LiDAR systems.

The reference values (R) are passed from the scan profile generator to the error calculator 708. The error calculator 708 subtracts the data set (y) from the reference values (R) to determine an error value (E) to pass to the controller 702 in conjunction with the reference values (R) to guide the controller 702 in driving the opto-mechanical scanner system 704. In addition, the error value (E) and reference values (R) are used as an input to a trajectory feed forward calculator 718 that monitors for error between the final instructions sent to the controller 703 and the actual timing and position values (y) output by the controller 702. The error calculations by the trajectory feed forward calculator 718 are used to further minimize error between the final control output (y) and the reference values (R) as the scan profile changes the reference values (R). Error adjustments determined by the trajectory feed forward calculator 718 are also considered by the error calculator 708 for adjustment of the error value (E).

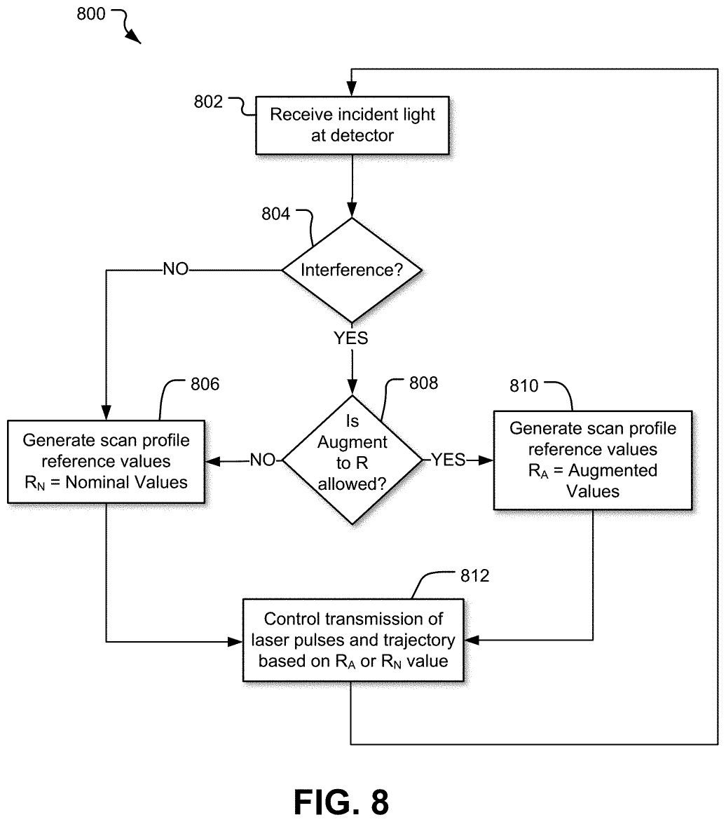

An example method 800 for LIDAR interference detection and mitigation of light signals from non-co-located light sources, for example, performed by the system 700 described in FIG. 7, is depicted in FIG. 8. In this implementation, the method 800 begins in a receiving operation 802 when incident light is received at a detector. Next, in an identification operation 804, a determination of whether there is light interference, e.g., from another LiDAR system or a light jamming source, is made, for example, by the optical interference identifier 712 of FIG. 7. If no interference is identified, then a scan profile of reference values (R) is generated in a generation operation 806, wherein the reference values (R_{N}) are the nominal values for the LiDAR system. Then, in a controlling operation 812, the timing and trajectory of the transmission of a laser pulse is controlled based, at least in part, upon the reference value (R_{N}).

Alternatively, if interference is detected in identification operation 804, then a query operation 808 interrogates whether an augmented reference value (R_{A}) should be used to mitigate interference. Different treatment in use of augmented reference values (R_{A}) may be driven by differing circumstances. For example, the LiDAR system may encounter at an operating environment in which augmentation to the scan field is not a physical possibility, i.e., in a high-resolution area in which the limit of the mechanical/electrical/processing systems is reached and additional processing of changes to nominal values is too taxing. Such limits could include the range of vertical scanning, the maximum rotational rate of the spinning horizontal mirror, or the power limits of the laser. In such cases, changes to scanning profiles may not be possible or practical. In contrast, an event where changes to reference values are possible may be when the mechanical/electrical/processing systems have some freedom of adjustment, and the interference identifier estimates (guesses) the source of the interference. If the source is external and un-familiar (i.e., likely not from a similar LiDAR device scanning the same scene) then scan profile generator may not change, or may quickly return to, the nominal reference value (R_{N}) because the interference was likely a one-off event that can safely be ignored. However, if the interfering source is estimated to be a similar LiDAR system, then the scan profile generator may calculate an augmented reference value (R_{A}), e.g., a random profile dither, that will probabilistically step away from the interfering signal.

If the sample examined in identification operation 804 is a new instance of interference, the query operation 808 may indicate that augmented reference values (RA) should be used for interference mitigation. Alternatively, for example, if a compression or stretching technique was used as a mitigation technique in the prior cycle due to prior detected interference, and if interference was detected in the present light sample, then the query operation 808 may indicate that augmented reference values (R_{A}) should again be used for interference mitigation in the present cycle. If augmented reference values (R_{A}) are determined appropriate, either in response to a new incidence of interference or a prior use of a compression or stretching technique, a scan profile of reference values (R) is generated in a generation operation 810, wherein the reference values (R_{A}) are augmented values that differ from the nominal values in order to mitigate the interference. Alternatively, for example, if a dither mitigation technique was used in the immediately prior cycle due to prior detected interference, then the method 800 may direct as the output of query operation 808 that the next cycle for trajectory control of the laser pulse use the nominal reference values (R_{N}) and generation operation 808 may be triggered, regardless of whether interference is detected in the present received light sample.

Finally, in a controlling operation 812, the timing and trajectory of the transmission of a laser pulse is controlled based, at least in part, upon either the nominal reference values (R_{N}) or augmented reference values (R_{A}). Once the laser pulses are generated based upon the selected reference value, the method 800 cycles back to receiving operation 802 for examining the next sample.

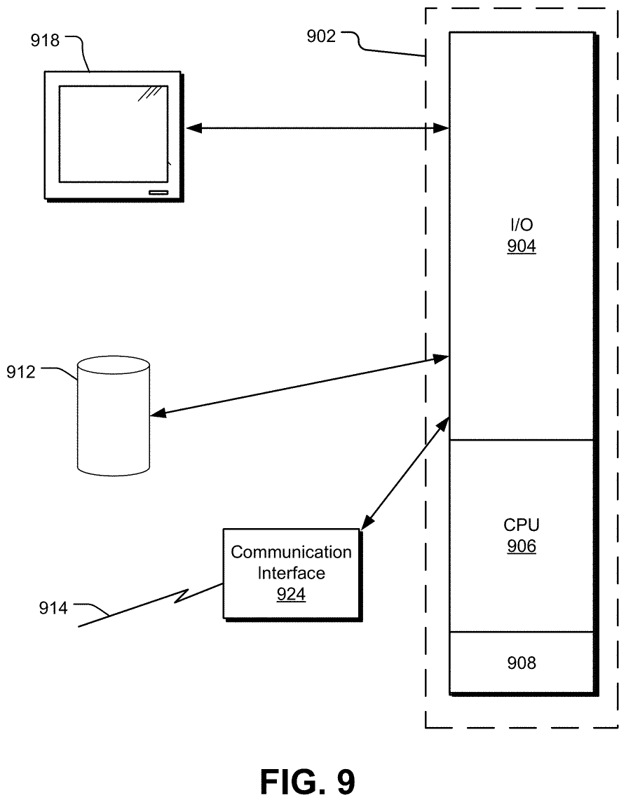

FIG. 9 illustrates an example processing system 900 that may be useful in implementing the described technology. The processing system 900 may be implemented in a device attached to the LiDAR device, such as a user device, storage device, internet of things (IoT) device, a desktop computer, a laptop computer, or a processing system integrated into device or a vehicle in which the LiDAR is mounted, e.g., a security camera, an automobile, a drone, etc. The processing system 900 is capable of executing a computer program product embodied in a tangible computer-readable storage medium to execute a computer process. Data and program files may be input to the processing system 900, which reads the files and executes the programs therein using one or more processors (CPUs or GPUs). Some of the elements of a processing system 900 are shown in FIG. 9 wherein a processor 902 is shown having an input/output (I/O) section 904, a central processing unit (CPU) 906, and a memory section 908.

There may be one or more processors 902, such that the processor 902 of the processing system 900 comprises a single central-processing unit 906, or a plurality of processing units. The processors may be single core or multi-core processors. The processing system 900 may be a conventional computer, a distributed computer, or any other type of computer. The described technology is optionally implemented in software loaded in memory 908, a storage unit 912, and/or communicated via a wired or wireless network link 914 on a carrier signal (e.g., over Ethernet, a wireless local area network (LAN) protocols, Long Term Evolution(LTE) or 3/4/5G wireless, etc.) thereby transforming the processing system 900 in FIG. 9 into a special purpose machine for implementing the described operations.

The I/O section 904 may be connected to one or more user-interface devices (e.g., a keyboard, a touch-screen display unit 918, etc.) or a storage unit 912. Computer program products containing mechanisms to effectuate the systems and methods in accordance with the described technology may reside in the memory section 908 or on the storage unit 912 of such a system 900.

A communication interface 924 is capable of connecting the processing system 900 to an enterprise network via the network link 914, through which the computer system can receive instructions and data embodied in a carrier wave. When used in a LAN environment, the processing system 900 may be connected by wired connection (e.g., Ethernet) or wirelessly (e.g., through a wireless access point or router using 902.11 protocols) to a local network through the communication interface 924. When used in a wide-area-network (WAN) environment, the processing system 900 typically includes a modem, a network adapter, or any other type of communications device for establishing communications over the WAN. In a networked environment, program modules depicted relative to the processing system 900 or portions thereof, may be stored in a remote memory storage device. It is appreciated that the network connections shown are examples of communications devices for and other means of establishing a communications link between the computers may be used.

In an example implementation, a user interface software module, a communication interface, an input/output interface module, a ledger node, and other modules may be embodied by instructions stored in memory 908 and/or the storage unit 912 and executed by the processor 902. Further, local computing systems, remote data sources and/or services, and other associated logic represent firmware, hardware, and/or software, which may be configured to assist in supporting a distributed ledger. In addition, keys, device information, identification, configurations, etc. may be stored in the memory 908 and/or the storage unit 912 and executed by the processor 902.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

The embodiments of the invention described herein are implemented as logical steps in one or more computer systems. The logical operations of the present invention may be implemented (1) as a sequence of processor-implemented steps executing in one or more computer systems or (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only, and the dimensions, positions, order, and relative sizes reflected in the drawings attached hereto may vary.

The above specification, examples, and data provide a thorough description of the structure and use of exemplary embodiments of the invention as defined in the claims. Although various embodiments of the claimed invention have been described above with a certain degree of particularity or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method of interference mitigation in a LiDAR system, the method comprising
identifying a presence or absence of interference from a non-co-located light source in a sample of incident light received by a detector in the LiDAR system;
in the absence of interference,
using a nominal set of reference values for one or more spacio-temporal scanning profile trajectory parameters; and
controlling one or more scanner components of the LiDAR system using the nominal set of reference values; and
in the presence of interference,
augmenting the nominal set of reference values, resulting in an augmented set of reference values, to modify the spacio-temporal scanning profile trajectory parameters; and
controlling the one or more scanner components of the LiDAR system using the augmented set of reference values to avoid detection of and interference by the non-co-located light source.

2. The method of claim 1, wherein the augmenting step further comprises dithering one or more of the spacio-temporal scanning profile trajectory parameters.

3. The method of claim 2, wherein the dithering of the one or more of the spacio-temporal scanning profile trajectory parameters further comprises offsetting an angular sample trajectory from a nominal sampling trajectory.

4. The method of claim 3 further comprising determining the offset of the angular sample trajectory as a random value.

5. The method of claim 2, wherein the dithering of the one or more of the spacio-temporal scanning profile trajectory parameters further comprises offsetting a sample timing window for detecting reflected light signals at the detector from a nominal sample timing window.

6. The method of claim 5 further comprising determining a timing of the offsetting as a random value.

7. The method of claim 1, wherein the augmenting step further comprises one or more of stretching or compressing one or more of the spacio-temporal scanning profile trajectory parameters.

8. The method of claim 7, wherein the stretching or compressing the one or more of the spacio-temporal scanning profile trajectory parameters further comprises one or more of stretching or compressing an angular sample trajectory from a nominal sampling trajectory.

9. The method of claim 8 further comprising randomly generating a profile of the one or more of the stretching or compressing of the angular sample trajectory.

10. The method of claim 7, wherein the stretching or compressing the one or more of the spacio-temporal scanning profile trajectory parameters further comprises one or more of stretching or compressing a sample timing window for detecting reflected light signals at the detector from a nominal sample timing window.

11. The method of claim 10 further comprising randomly generating a length for the one or more of the stretching or compressing of the sample timing window.

12. The method of claim 1, wherein the augmenting step further comprises
modeling sensor sampling trajectories for known LiDAR sensors which can interfere with the LiDAR system; and
adjusting the nominal set of reference values based, at least in part, on the modeled sensor sampling trajectories to mitigate interference by avoiding the modeled sensor sampling trajectories.

13. A LiDAR device including a system for mitigating interference from a non-co-located light source, the system comprising
a detector that identifies a presence or absence of interference from a non-co-located light source in a sample of incident light received at the detector;
a scan profile generator configured to
in the absence of interference, generate a nominal set of reference values for one or more spacio-temporal scanning profile trajectory parameters; and
in the presence of interference, adjust the nominal set of reference values to generate an augmented set of reference values to modify the spacio-temporal scanning profile trajectory parameters; and
a controller that controls one or more scanner components of the LiDAR device using either the nominal set of reference values or the augmented set of reference values to avoid detection of and interference by the non-co-located light source.

14. The LiDAR device of claim 13, wherein the augmented reference values comprise values that cause the controller to dither one or more spacio-temporal scanning trajectories.

15. The LiDAR device of claim 14, wherein the dither implemented by the controller further comprises offsetting an angular sample trajectory from a nominal sampling trajectory.

16. The LiDAR device of claim 14, wherein the dither implemented by the controller further comprises offsetting a sample timing window for detecting reflected light signals at the detector from a nominal sample timing window.

17. The LiDAR device of claim 13, wherein the augmented reference values comprise values that cause the controller to stretch or compress, or both, one or more of the spacio-temporal scanning trajectories.

18. The LiDAR device of claim 17, wherein the stretch or compress implemented by the controller further comprises one or more of stretching or compressing an angular sample trajectory from a nominal sampling trajectory.

19. The LiDAR device of claim 17, wherein the stretch or compress implemented by the controller further comprises one or more of stretching or compressing a sample timing window for detecting reflected light signals at the detector from a nominal sample timing window.

20. The LiDAR device of claim 13, wherein the scan profile generator further
references modeled sensor sampling trajectories for known LiDAR sensors which can interfere with the LiDAR device; and
adjusts the nominal set of reference values to generate the augmented set of reference values based, at least in part, on the modeled sensor sampling trajectories to mitigate interference by avoiding the modeled sensor sampling trajectories.
